(19) United States
(12) Patent Application Publication
(10) Pub. No.: US 2013/0115503 A1
(43) Pub. Date: May 9, 2013

(54) MOUNTING DEVICE FOR BATTERY

(71) Applicant: Hai-Qing ZHOU, Shenzhen City (CN)

(72) Inventor: Hai-Qing ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/296,240

(22) Filed: Nov. 15, 2011

(30) Foreign Application Priority Data
Nov. 4, 2011 (CN) 201110344353.X

(51) Int. Cl. H01M 2/10

(52) U.S. Cl. 429/100

(57) ABSTRACT

A mounting device for mounting a battery includes a base board to support the battery and a fixing member. The base board forms two hooks to abut against opposite sides of the battery, a tab and two protrusions to respectively abut opposite ends of the battery. The fixing member includes a blocking portion to block a top of the battery, two first latching portions to engage with the corresponding hooks, and two second latching portions to be pivotably connected to the protrusions.

### CROSS-REFERENCE OF RELATED APPLICATIONS

Relevant subject matter is disclosed in two pending U.S. patent applications, both titled “MOUNTING DEVICE FOR BATTERY”, respectively filed on Nov. 9, 2011, and Nov. 11, 2011, with the application Ser. Nos. 13/293,082 and 13/294,192, which are assigned to the same assignee as this patent application.

### BACKGROUND

1. Technical Field

The present disclosure relates to a device for mounting a battery.

2. Description of Related Art

In an electronic device, such as a server, a redundant array of independent disk (RAID) cards is electrically connected to a battery, to protect cached data from being lost because of a power failure. However, the mounting of the battery to the chassis of the server with screws is less than optimal in a maintenance or replacement operation.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a mounting device together with a battery.

FIG. 2 is an assembled, isometric view of the mounting device and the battery of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

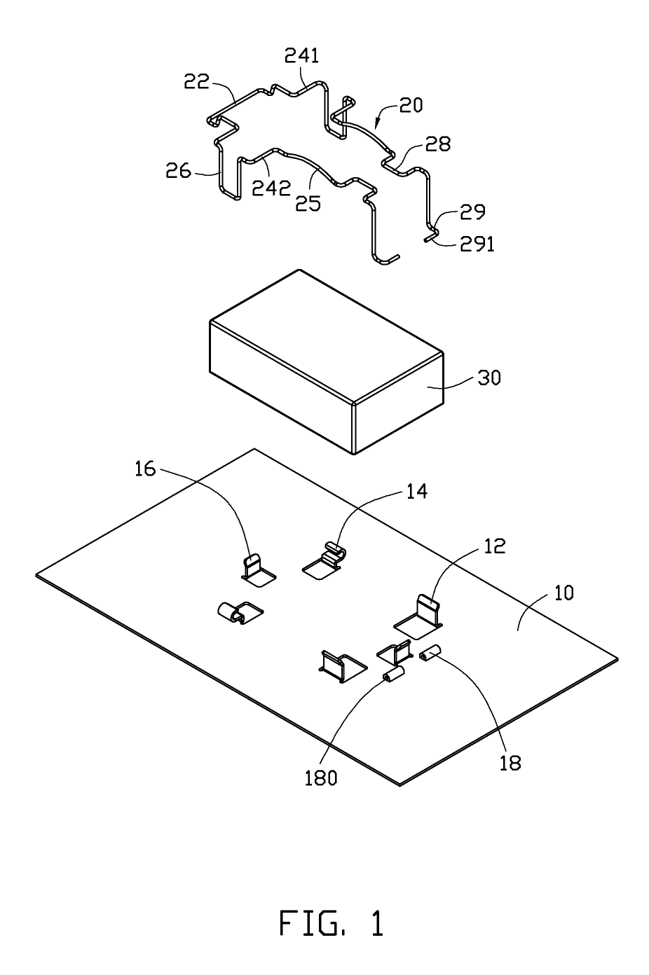

Referring to FIG. 1, an exemplary embodiment of a mounting device for mounting a battery 30 includes a base board 10 and a fixing member 20.

Two opposite hooks 14 and two opposite first elastic tabs 12 extend up from the base board 10 forming the corners of an imaginary rectangle. Two opposite second elastic tabs 16 respectively positioned adjacent to the hooks 14 and the first tabs 12 extend up from the base board 10. The second tabs 16 are perpendicular to the first tabs 12 and are respectively set between the first tabs 12. Upper portions of the first and second tabs 14 and 16 slant outward. Two protrusions 18 are formed on the base board 12 at the outer side of one of the second tabs 16. Each protrusion 18 axially defines a fixing hole 180.

The fixing member 20 is a deformable metal pole. The fixing member 20 includes a substantially U-shaped first connection portion 22 at a first end of the fixing member 20, two substantially U-shaped first latching portions 26 at opposite sides of the fixing member 20, and two substantially L-shaped second latching portions 29 at a second end of the fixing member 20 opposite to the first end. First and second blocking portions 241 and 242 which are substantially L-shaped extend from distal ends of each first latching portion 26. Distal ends of the first connection portion 22 perpendicularly extend up to connect to the corresponding first blocking portions 241. An arc-shaped second connection portion 25 extends from a distal end of each second blocking portion 242 away from the first connection portion 22. A substantially U-shaped third blocking portion 28 extends from a distal end of each second connection portion 25 opposite to the second blocking portion 242 toward the other second connection portion 25. The second latching portions 29 extend down from distal ends of the corresponding third blocking portions 28. Two pins 291 perpendicularly extend toward each other from distal ends of the second latching portions 29.

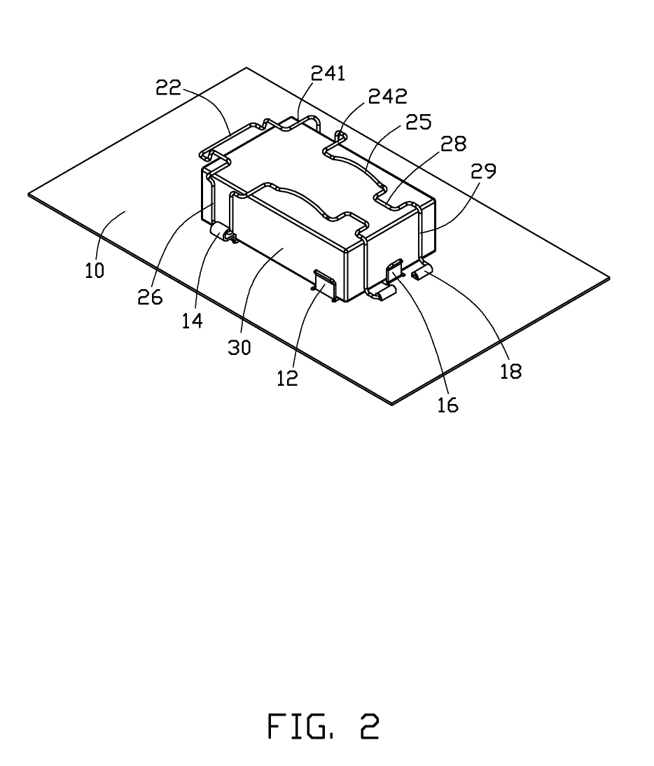

Referring to FIG. 2, in assembly, the battery 30 is put on the base board 10 and is accommodated in the space among the hooks 14, the first and second tabs 12 and 16. The slanted upper portions of the first and second tabs 12 and 16 guide the battery 30 down into the space bounded by the hooks 14 and the first and second tabs 12 and 16. The lower portions of the hooks 14, the first and second tabs 12 and 16 hold the battery 30 captive. The first to third blocking portions 241, 242, and 28 abut against a top of the battery 30. The first latching portions 26 are latched with the corresponding hooks 14. The second latching portions 29 are deformed away from each other, allowing the pins 291 to be pivotably engaged in the fixing holes 180 of the corresponding protrusions 18. In this way, the battery 30 is held in place from every direction but may quickly and easily be removed and replaced.

In another embodiment, each first tab 12 may be replaced by a hook 14.

In another embodiment, the second tabs 16 adjacent to the protrusions 18 may be replaced by the two protrusions 18, so the protrusions 18 can directly abut against the corresponding end of the battery 30.

In another embodiment, there can be just one protrusion 18.

In another embodiment, each second tab 16 can be replaced by a protrusion 18.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a battery, comprising:
a base board to support the battery, the base board forming two hooks to abut against opposite sides of the battery, a tab and two protrusions to respectively abut opposite ends of the battery; and
a fixing member comprising at least one blocking portions to block a top of the battery, two first latching portions to latch with the corresponding hooks, and two second latching portions to be pivotably connected to the protrusions.

2. The mounting device of claim 1, wherein the fixing member is a deformable metal pole.

3. The mounting device of claim 1, wherein each first latching portion is substantially U-shaped.

4. The mounting device of claim 1, wherein a fixing hole is defined in each protrusion, each second latching portion is substantially L-shaped, a pin extends from each second latching portion to engage in a corresponding one of the fixing holes.

5. The mounting device of claim 1, wherein the at least one blocking portion comprises two first blocking portions extending from top ends of the first latching portions, and two second blocking portions each respectively connected between a second latching portion and a corresponding first blocking portion.

6. A battery assembly, comprising:
a base board supporting the battery, the base board forming two hooks abutting against opposite sides of the battery, a tab and two protrusions respectively abuting opposite ends of the battery; and
a fixing member comprising at least one blocking portions blocking a top of the battery, two first latching portions latching with the corresponding hooks, and two second latching portions pivotably connected to the protrusions.

7. The battery assembly of claim 6, wherein the fixing member is a deformable metal pole.

8. The battery assembly of claim 6, wherein each first latching portion is substantially U-shaped.

9. The battery assembly of claim 6, wherein a fixing hole is defined in each protrusion, each second latching portion is substantially L-shaped, a pin extends from each second latching portion to engage in a corresponding one of the fixing holes.

10. The battery assembly of claim 6, wherein the at least one blocking portion comprises two first blocking portions extending from top ends of the first latching portions, and two second blocking portions each respectively connected between a second latching portion and a corresponding first blocking portion.
